(19) United States
(12) Patent Application Publication
(10) Pub. No.: US 2011/0181577 A1
(43) Pub. Date: Jul. 28, 2011

(54) Drive circuit and drive method

(75) Inventor: Hiroaki Shirai, Kanagawa (JP)

(73) Assignee: Renesas Electronics Corporation, Kawasaki-shi (JP)

(21) Appl. No.: 12/929,332

(22) Filed: Jan. 14, 2011

(30) Foreign Application Priority Data
Jan. 25, 2010 (JP) 2010-013375

(51) Int. Cl. G09G 3/36; G06F 3/038

(52) U.S. Cl. 345/211; 345/100

(57) ABSTRACT

A drive circuit and drive method for lowering electrical current consumption by stopping individual operational amplifiers during writing onto pixels. The drive circuit of an embodiment of the present invention is comprised of a plurality of amplifier circuits formed for each different generated voltage potential based on a reference voltage; and a control unit for grouping a plurality of amplifier circuits to output adjacent gradation voltage into groups of two or more, and controlling individually turning single amplifier circuit and all other amplifier circuits in each group on and off.

### CROSS-REFERENCE TO RELATED APPLICATIONS

The disclosure of Japanese Patent Application No. 2010-13375 filed on Jan. 25, 2010 including the specification, drawings and abstract is incorporated herein by reference in its entirety.

### BACKGROUND

1. Field of the Invention

The present invention relates to a drive circuit and a drive method for display devices.

2. Description of Related Art

The use of portable display devices in recent years typified by cellular telephones has made energy-saving essential in order to extend usage time in display control circuits for liquid crystal displays that drastically affect the battery usage time. Achieving low-power consumption or energy-saving in display control circuits requires efficient drive methods and drive circuits that use those methods.

The technology in Japanese Unexamined Patent Publication No. 2008-129386 discloses a drive circuit for shortening the write period onto the pixel by separately controlling an initial first period of the write period, and a following second period. FIG. 9 shows a block diagram of the structure of the liquid crystal display device described in Japanese Unexamined Patent Publication No. 2008-129386 is shown in FIG. 9. A diagram showing the structure of the source driver 15 of Japanese Unexamined Patent Publication No. 2008-129386 is shown in FIG. 10.

An operational amplifier (hereafter called, “op-amp”) is formed in each of the nodes of the gradation setter unit 20 in source driver 15 as shown in FIG. 10.

Until reaching a full charge after writing starts in the first period, the pixel charges to the gradation voltage potential of the designated node in the node group containing the node that must reach the target gradation voltage. Moreover, multiple wiring equivalent to the number of nodes in the node group is coupled in parallel between the designated node and the pixels. In the second period after the pixel has charged up to the target gradation voltage potential, the above described parallel coupling is eliminated and only the node matching the target gradation voltage potential remain coupled to the pixel.

FIG. 11 shows the voltage potential V_A1 (a) for node A1, the control signal SN1 (b), and the control signal SC1 (c). FIG. 11 shows the waveform when the target gradation voltage is between V1 through V4 (gradation voltage of node group GN1). As shown in FIG. 11, multiple wiring is coupled in parallel between the specified node and the pixel so that the wiring resistance drops and the pixel can charge within a short time. Afterwards, in the second period, the pixel can charge up to the target gradation voltage potential by coupling only to the specified node.

The technology in Japanese Unexamined Patent Publication No. 2009-145639 discloses a drive circuit for lowering electrical power consumption by shorting one end of a first stored charge element and one end of a second stored charge element, to set an intermediate voltage potential when switching one end of the first stored charge element and one end of the second stored charge element between a high voltage potential and a low voltage potential.

However these drive circuits contained no function for partial control of the op-amps and therefore have the problems that all of the op-amps are operating during the period when writing onto the pixel and that there is large electrical current consumption.

### SUMMARY

The drive circuit of the conventional art therefore had the problem of large current consumption because all the op-amps are operated during writing onto the pixels.

The drive circuit according to an aspect of the present invention includes multiple amplifier circuits formed for each different gradation voltage potential generated based upon a reference voltage; and a control circuit for separately switching on or off: one amplifier circuit, and all other amplifier circuits within each group of amplifiers by grouping the multiple amplifier circuits for outputting adjacent voltages into sub-groups of two or more amplifier circuits.

The drive method according to another aspect of this invention groups multiple amplifier circuits formed for each different gradation voltage generated based upon the reference voltages, into two or more amplifier circuits to output the adjacent gradation voltages; in the first period during the period when writing onto the pixel, operates a single amplifier circuit, and stops all other amplifier circuits in each group, in order to write onto the pixel from the amplifier circuit with the corresponding data in the second period following the first period.

This type of structure which groups amplifier circuits formed at each different gradation voltage into units of two or more adjacent amplifier circuits to output the gradation voltages; is capable of separately switching on and off one op-amp circuit and all other op-amps in each group. Electrical power consumption can therefore be reduced in this way by operating only one op-amp within each group in the first period in the period for writing onto the pixel.

The present invention can separately stop the op-amps in the period when writing onto the pixels and is therefore capable of reducing the electrical power consumption

### BRIEF DESCRIPTION OF THE DRAWINGS

FIG. 1 is a block diagram showing the structure of the display device utilizing the drive circuit of the first embodiment;

FIG. 2 is a drawing showing the structure of the drive circuit of the first embodiment;

FIG. 3A is a drawing showing each type of control signal waveform from the control unit supplied by drive circuit of the first embodiment;

FIG. 3B is a graph showing the voltage fluctuations in the data line DL_m;

FIG. 4A is a truth table showing the logic operation for the 64 gradation in the gradation voltage selector circuit of the drive circuit of the present embodiment;

FIG. 4B is a truth table showing the logic operation for the 64 gradation in the gradation voltage selector circuit of the drive circuit of the present embodiment;

FIG. 5 is a circuit diagram showing the structure of the drive circuit of the second embodiment;

FIG. 6A is a drawing showing each type of control signal waveform from the control unit supplied by drive circuit of the second embodiment;

FIG. 6B is a graph showing the voltage fluctuations in the data line DL_m;

FIG. 7 is a graph showing an example of the γ (gamma) curve for the 64 gradations;

FIG. 8 is a circuit diagram showing the structure of the drive circuit of the third embodiment;

FIG. 9 is a block diagram showing the structure of the display device described in Japanese Unexamined Patent Publication No. 2008-129386;

FIG. 10 is a circuit diagram showing the structure of the drive circuit described in Japanese Unexamined Patent Publication No. 2008-129386;

FIG. 11 is a diagram for describing the operation of the drive circuit described in Japanese Unexamined Patent Publication No. 2008-129386.

### DETAILED DESCRIPTION OF THE PREFERRED EMBODIMENTS

### First Embodiment

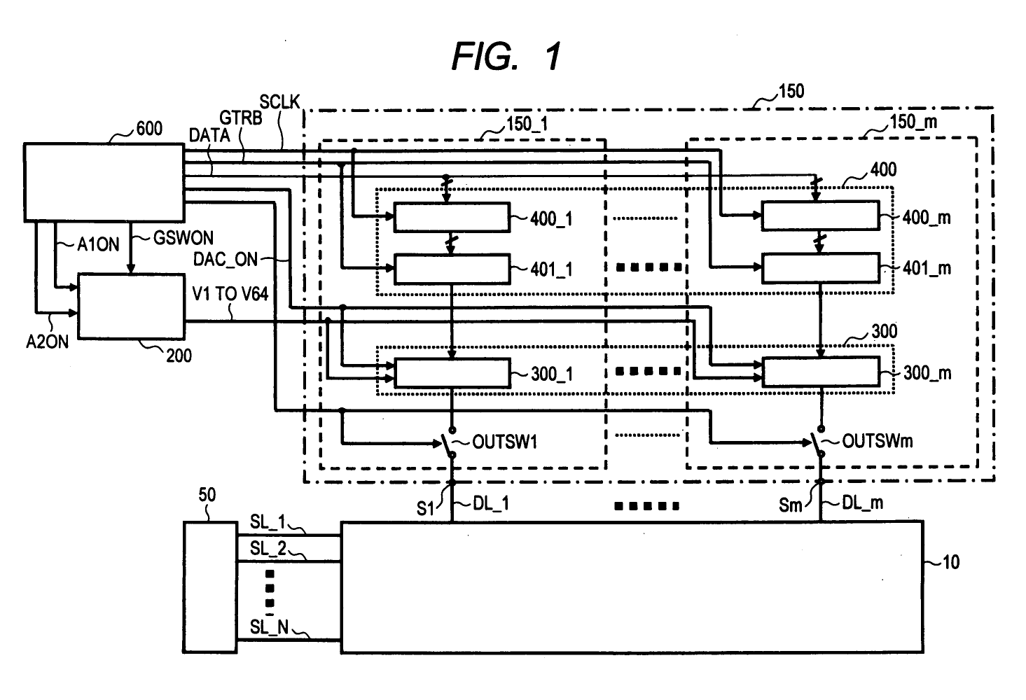

The structure of the display device utilizing the drive circuit of the first embodiment of the present invention is described next while referring to FIG. 1. FIG. 1 is a block diagram showing the entire structure of the display device in the embodiment. The example described in this embodiment describes a drive circuit for processing 64 gradation display data, however the present invention is not limited to this example.

The display device of this embodiment as shown in FIG. 1 is comprised of a liquid crystal panel (hereafter referred to as, LCD (Liquid Crystal Display) 10, a source driver unit 150, a gate driver 50, a gradation voltage generator circuit 200, and a control unit 600. The drive circuit of the present invention is comprised of a source driver unit 150, and a gradation voltage generator circuit 200.

Liquid crystal pixels (hereafter referred to as pixels) are arrayed in a matrix of j lines and m rows within the LCD panel 10. The pixels arrayed in this matrix are driven while coupled to j scanning lines SL_1 through SL_{—}j and m data lines DL_1 through DL_m.

Pixels are generally comprised of a thin film transistor (TFT) and a capacitor Cs and auxiliary capacitance Cj (not shown in drawing) for the liquid crystal cell. The capacitance Cs and auxiliary capacitance Cj are the capacitance across the drain electrode of the TFT and the common electrode (VCOM) of the LCD panel 10. The capacitance Cs and auxiliary capacitance Cj hold the electrical charge accumulated across one frame period.

Changing the orientation of the liquid crystal molecules according to the electrical charge quantity accumulated in the capacitor Cs and auxiliary capacitor Cj; and changing the amount of light transmittance from the backlight generates the gradation display. The TFT source electrode is coupled to the corresponding data line DL_1 through DL_m; and the TFT gate electrode is coupled to the corresponding scanning lines SL_1 through SL_j.

The gate driver 50 sequentially selects the scanning lines SL_1 through SL_j, switching on the TFT of pixels coupled to the selected scanning lines SL_1 through SL_j. While the TFT are switched on, the output terminals S1 through Sm of source driver unit 150 supply a gradation voltage corresponding to the display data, by way of the data lines DL_1 through DL_{—}m to the capacitor Cs and auxiliary capacitor Cj for each pixel.

The control unit 600 is a control circuit for controlling the gradation voltage generator circuit 200 and the source driver unit 150. The control circuit 600 transfers the display data DATA, the control signal DAC_ON, the control signal OUTSW_ON, the strobe signal STRB, and the clock signal SCLK to the source driver unit 150; and also transfers the control signal A1ON and the control signal A2ON and the control signal GSWON to the gradation voltage generator circuit 200.

The source driver unit 150 is comprised of a data latch unit 400, a DA converter circuit 300, and the switching elements OUTSW1 through OUTSWm. The data latch unit 400 is a two-stage structure comprised of the latch circuits 400_1 through 400_{—}m and the latch circuits 401_1 through 401_{—}m. The initial stage latch circuits 400_1 through 400_{—}m sequentially loads a one line portion of the display data DATA within one horizontal period in synchronization with the clock signal SCLK output from the control unit 600.

The second stage latch circuits 401_1 through 401_{—}m receives the data from the initial stage latch circuits 400_1 through 400_{—}m conveyed in synchronization with the strobe signal STRB output from the control unit 600. The strobe signal STRB is output in the initial horizontal period so that data from the second stage latch circuits 400_1 through 401_{—}m is retained within one horizontal period.

The DA converter circuit 300 is comprised of the gradation voltage select circuits 300_1 through 300_{—}m. The gradation voltage select circuits 300_1 through 300_{—}m outputs one optional gradation voltage from among the gradation voltages V1 through V64 from the gradation voltage generator circuit 200 according to data accumulated in the second stage latch circuits 400_1 through 401_{—}m.

The switch elements OUTSW1 through OUTSWm are installed between each source output terminal S1 through Sm and each gradation voltage select circuit 300_1 through 300_{—}m. Each of the switch elements OUTSW1 through OUTSWm are electrically shorted when the control signal OUTSW_ON is high. Each of the switch elements OUTSW1 through OUTSWm are electrically open when the control signal OUTSW_ON is low.

The source driver unit 150 is grouped into source driver circuits 150_1 through 150_{—}m corresponding to each of the source driver output terminals S1 through Sm. Each of the source driver circuits 150_1 through 150_{—}m includes two stage latch circuits, a gradation voltage selector circuit, and a switch element.

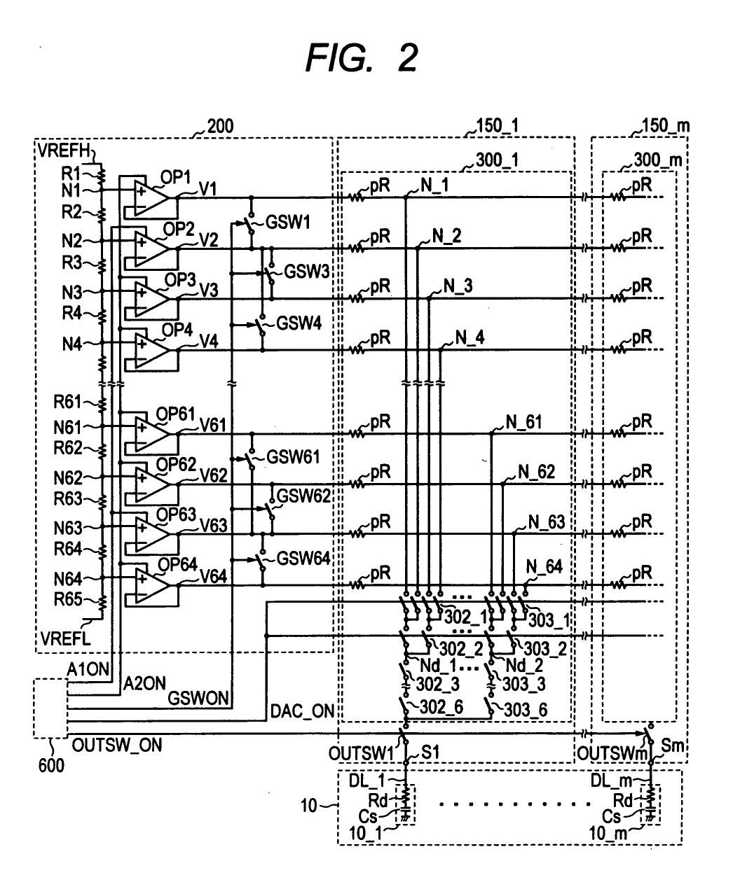

The drive circuit of this embodiment is described next while referring to FIG. 2. FIG. 2 is a drawing showing the structure of the drive circuit of this embodiment. In FIG. 2, the latch circuits 400_1 through 400_{—}m and the latch circuits 401_1 through 401_{—}m of the source driver circuits 150_1 through 150_{—}m are omitted.

The gradation voltage generator circuit 200 includes the resistors R1 through R65, the op-amps OP1 through OP64, and the switch elements GSW1 through GSW64 as shown in FIG. 2. The resistors R1 through R65 generate a gradation voltage reference potential. The resistors R1 through R65 are serially coupled between the high level reference voltage VREFH and the low level reference voltage VREFL. A node N1 is installed between the resistors R1 and R2, a node N2 between the resistor R2 and resistor R3, and so on, and a node N64 is installed between the resistor R64 and resistor R65. The voltage potential of each of the nodes N1 through N64 is the reference voltage potential for each gradation voltage.

Each of the nodes N1 through N64 are coupled to the non-inverting input terminals (+) of the op-amps OP1 through OP64. The output from the op-amps OP1 through OP64 is coupled to the inverting input terminals (−). The op-amps OP1 through OP64 in other words, comprise a voltage follower.

In the gradation voltage generator circuit 200, four adjacent gradations are set as one group. In the present embodiment, the op-amps OP1 through OP4 are set as one group; the op-amps OP5 through OP8 as one group; and so on, and the op-amps OP61 through OP64 are set as one group.

The op-amps OP1 through OP64 respectively output the gradation voltages V1 through V64. If the gradation voltage V1 is a high voltage potential and the gradation voltage V64 is a low voltage potential; then the optimal gradation voltage is the second highest gradation voltage from among the (high gradation voltage side) of V1 through V32 that were sub-grouped into four gradations each. The optimal gradation voltage among the gradation voltages V1 through V4 for example is the gradation voltage V2.

Moreover, among the low gradation voltage side of gradation voltage group V33 through V64, the optimal gradation voltage is the second lowest voltage from the sub-groups of four gradations each. The optimal gradation voltage among the gradation voltages V61 through V64 for example is the gradation voltage V63. This optimal gradation voltage is described later on.

The control unit 600 controls the op-amps OP1 through OP64 grouped into four gradations by way of the control signals A1ON and A2ON. The control signal A1ON controls the op-amp (OP2, OP6, . . . , OP63) that outputs the optimal gradation voltage. If the control signal A1ON for example is high then the op-amps (OP2, OP6, . . . , OP63) that output the optimal gradation voltage set to the operating state. If the control signal A1ON is low, then the op-amps (OP2, OP6, . . . , OP63) that output the optimal gradation voltage set to the stop state and their output moreover is in a HiZ (high-impedance) state.

The control unit 600 controls op-amps other than for outputting an optimal gradation voltage (OP1, OP3, OP4, . . . , OP61, OP62, OP64) by way of the control signal A2ON. If the control signal A2ON for example is high, then the op-amps (OP1, OP3, OP4 - - - OP61, OP62, OP64) are in the operating state. If the control signal A2ON is low, then the op-amps (OP1, OP3, OP4 - - - OP61, OP62, OP64) set to the stop state and their output moreover is in a HiZ (high-impedance) state.

The switch elements GSW1 through GSW64 are installed along the wiring that outputs the optimal gradation voltages and other gradation voltages grouped into sub-groups of four gradations each. Among the gradation voltages V1 through V4 in the group with high gradation voltages for example, the optimal gradation voltage is V2. The switch element GSW1 is therefore installed between the gradation voltage V1 and gradation voltage V2, the switch element GSW3 between the gradation voltage V2 and gradation voltage V3, and the switch element GSW4 between the gradation voltage V2 and gradation voltage V4.

The optimal gradation voltage is V63 among the gradation voltages V61 through V64 in the group with low gradation voltages. The switch element GSW61 is therefore installed between the gradation voltage V61 and the gradation voltage V63; a switch element GSW62 between the gradation voltage V62 and the gradation voltage V63; and a switch element GSW64 between the gradation voltage V63 and the gradation voltage V64.

The control unit 600 controls the switch elements GSW1 through GS64 by way of the control signal GSWON. If the GSWON for example is high then each of the switch elements GSW1 through GSW64 is electrically shorted state. If the GSWON is low then each of the switch elements GSW1 through GSW64 is in an electrically open state.

The wiring resistance pR for the gradation wiring expresses the parasitic resistance component in the aluminum wiring itself. The gradation voltage select circuits 300_1 through 300_{—}m are comprised of the switch elements 302_1 through 302_6, and the switch elements 303_1 through 303_6. The switch elements 302_1 and 303_1 correspond to the lowest order bits of the display data; and the switch elements 302_2 and 303_2 correspond to the second bit from the bottom of the display data.

The switch elements 302_1 and 303_1, and the switch elements 302_2 and 303_2 are controlled by way of the control signal DAC_ON from the control unit 600 and are not dependent on the display data. When the control signal DAC_ON is high, all of the switch elements 302_1 and 303_1, and switch elements 302_2 and 303_2 are set to an electrically shorted state (hereafter described as parallel operation). In parallel operation, the nodes Nd_1 and, N_1 and, N_2 and, N_3, N_4 are set to the same voltage potential; and the node Nd-2 and, N_61 and, N-62 and, N_63, N_64 are set to the same electrical potential.

The switch elements 302_3 through 302_6, and the switch elements 303_3 through 303_6 are switched on and off according to data other than the lower two bits of display data.

The switch elements OUTSW1 through OUTSWm are output terminals for the source driver 150 and are installed between each of the source output terminals S1 through Sm and the gradation voltage select circuits 300_1 through 300_{—}m. If the control signal OUTSW_ON is high, then the switch elements OUTSW1 through OUTSWm are set to an electrically shorted state. If the control signal OUTSW_ON is low, then the switch elements OUTSW1 through OUTSWm are set to an electrically open state.

When the switch elements OUTSW1 through OUTSWm are in an electrically shorted state, gradation voltages from any one of an optional gradation voltage V1 through V64 selected by the gradation voltage select circuits 300_1 through 300_{—}m is output from the source output terminals S1 through Sm to each of the pixels 10_1 through 10_{—}m by way of the data lines DL_1 through DL_m.

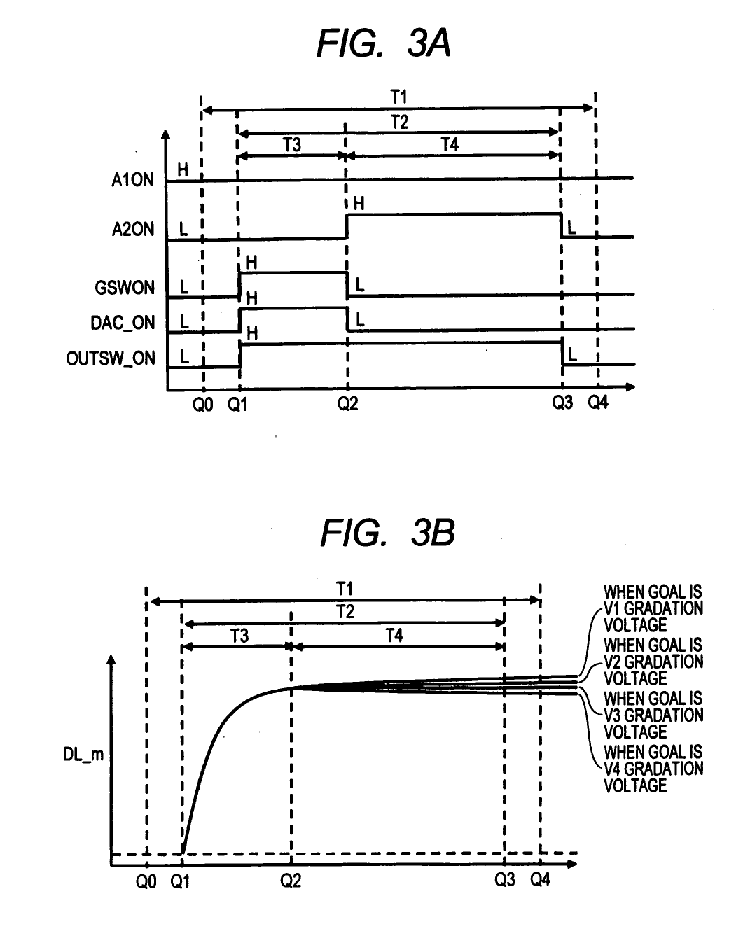

The operation of the drive circuit of this embodiment is here described next while referring to FIG. 3A and FIG. 3B. FIG. 3A shows the waveforms for each type of control signal (A1ON, A2ON, GSWON, DAC_ON, OUTSW_ON) that the control unit 600 supplies to the drive circuit. FIG. 3B is a graph showing the fluctuations in voltage potential along the data line DL_m. The example in the figure shows the case where any of the gradation voltages V1 through V4 are the voltage potential on the data lines DL_{—}m during writing onto the pixel.

In FIG. 3A and FIG. 3B, the horizontal axis indicates the time and the vertical axis indicates the voltage amplitude. FIG. 3A shows each of the high and low levels for the respective control signals (A1ON, A2ON, GSWON, DAC_ON, OUTSW_ON). These control signals are also digital signals. In FIG. 3A and FIG. 3B, the period T1 between of Q0 through Q4 is a single horizontal period, the period T2 for Q1 through Q3 is the write period for writing onto the pixel, the period T3 of Q1 through Q2 is the first period, and the period T4 of Q2 through Q3 is the second period.

In the horizontal front porch period of Q0 through Q1, the control signal states are set so that A1ON is in the high state, A2ON is low, GSWON is low, DAC_ON is low, and the OUTSW_ON is low. In this period, only the op-amps (OP2, OP6, . . . , OP63) that output the optimal gradation voltage operate among the op-amps OP1 through OP64 divided into sub-groups of four gradations each; and all other op-amps (OP1, OP3, OP4, OP5, OP7, OP8, . . . , OP61, OP62, OP64) are in a stopped state. The electrical current consumption by the op-amp itself during the single horizontal period (Q0 through Q1) is therefore one-fourth (¼) of the total current consumption.

The first period utilizes parallel drive during the write period onto the pixel. During the first period for Q1 through Q2, the control signal A1ON is in the high state, the control signal A2ON is low, the control signal GSWON is high, the control signal DAC_ON is high, the control signal OUTSW_ON is set to the high state. The control signal GSWON switching to the high state, causes the switch element GSW1 through GSW64 to switch to the electrically shorted state. The op-amps (OP2, OP6, . . . , OP63) outputting the optimal gradation voltage each respectively drive four gradation lines. The wiring resistance in this case is therefore one-fourth of the wiring resistance when driving one gradation wire.

The control signal DAC_ON switching to the high state, causes the switch element 302_1 through 302_2, the switch element 303_1 through 303_2 of the lower two bits of the DA converter circuit 300 to set to an electrically shorted state regardless of the display data. The ON resistance of the switch elements 302_1 through 302_2 up to node Nd_1 therefore drops because the switch elements 302_1 through 302_2 are coupled in parallel. Moreover, the ON resistance of the switch elements 303_1 through 303_2 up to node Nd_21 therefore drops because the switch elements 303_1 through 303_2 are coupled in parallel.

In the second period of Q2 through Q3, the control signal A1ON is in the high state, the control signal A2ON is high, the control signal GSWON is low, the control signal DAC_ON is low, and the control signal OUTSW_ON is in the high state. In this period all of the op-amps OP1 through OP64 are in the operating state. The DA converter circuit 300 writes the data display dependent gradation voltage (any of voltages V1 through V4 in the example in FIG. 3) onto the pixels 10_1 through 10_{—}m.

Next, in the horizontal back porch period of the Q3 through Q4 period, the control signal states are sets so the control signal A1ON is in the high state, A2ON is low, GSWON is low, control signal DAC_ON is low, and the control signal OUTSW_ON is low. The writing onto the pixel ends in this way. In this period, only the op-amps (OP2, OP6, . . . , OP63) outputting the optimal gradation voltage operate from among the op-amps OP1 through OP64 divided into sub-groups of four gradations each, and all other op-amps (OP1, OP3, OP4, OP5, OP7, OP8, . . . , OP61, OP62, OP64) are in a stopped state. The electrical current consumption by the op-amp itself in this embodiment is therefore one-fourth (¼) of the total current consumption.

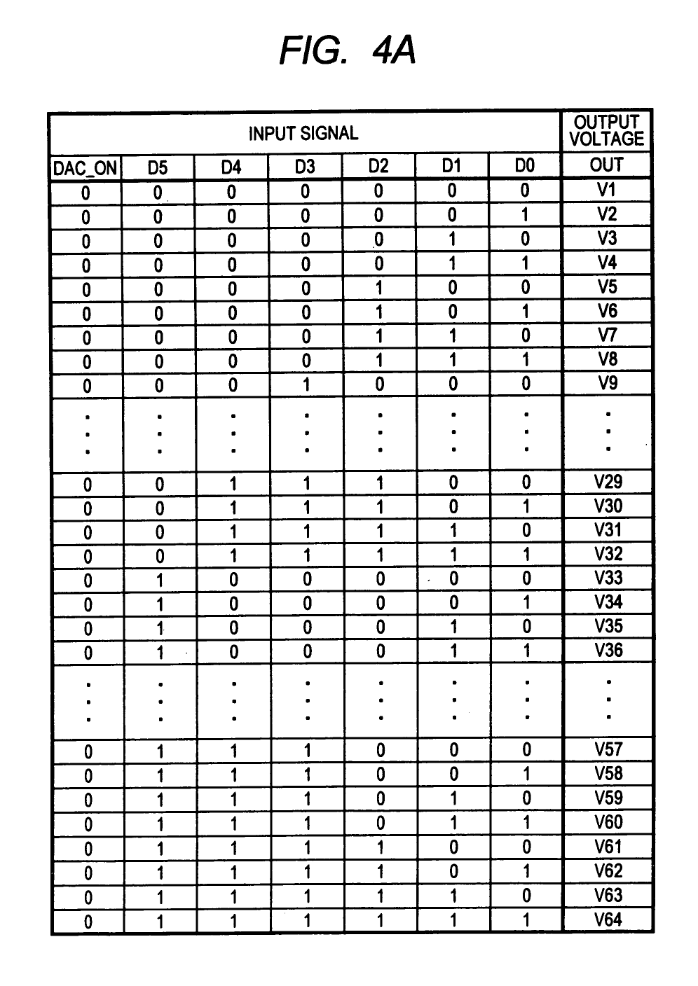

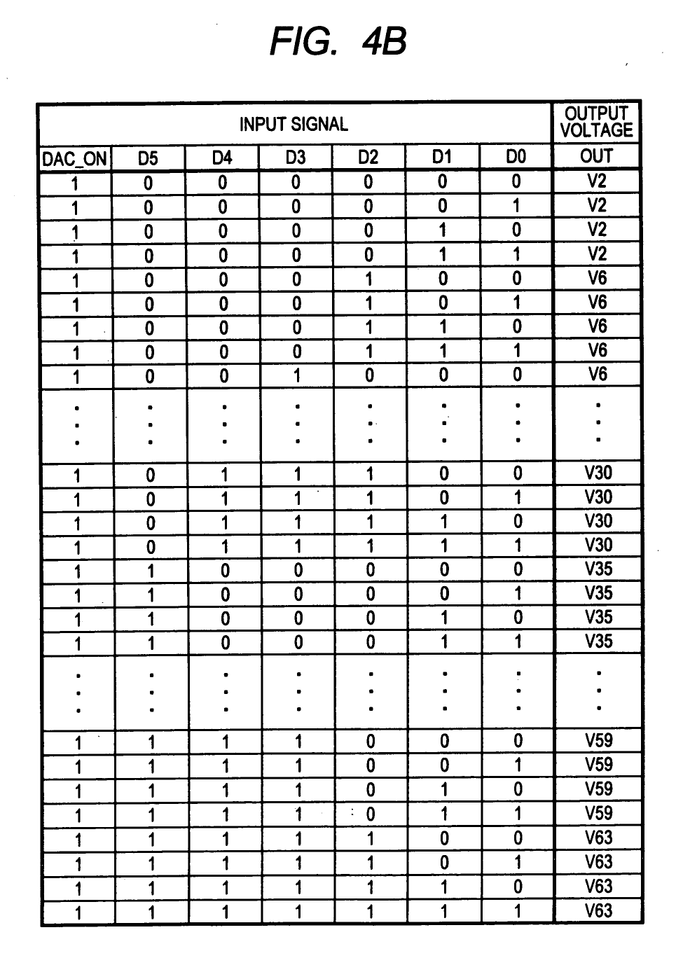

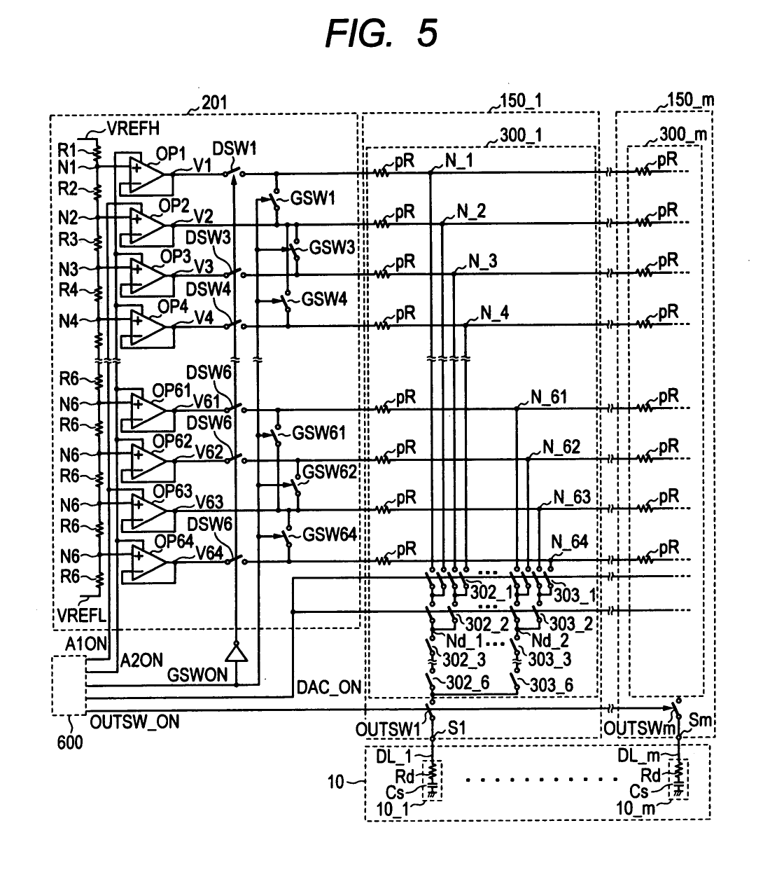

FIG. 4A and FIG. 4B are truth tables showing the logic operation 64 gradation (6 bits) of the gradation voltage select circuits 300_1 through 300_{—}m in the drive circuit for this embodiment. The above related optimal gradation voltage is described next while referring to FIG. 4A and FIG. 4B. In the actual display device AC drive inversion is utilized in each line or each frame to prevent burnout. Due to this inversion operation, the V1 voltage potential may be low and the V64 voltage potential may be high.

The gradation voltage relation for 64 gradations when established as gradation voltage V1>gradation voltage V2>gradation voltage V3 - - - > gradation voltage V64 is described using FIG. 4A and FIG. 4B. The input signals for the gradation voltage select circuits 300_1 through 300_{—}m are the control signal DAC_ON from the control unit 600, the display data D5 through D0 accumulated in the second stage latch circuits 401_1 through 401_{—}m, and the gradation voltages V1 through V64 from the gradation voltage generator circuit 200.

The output signals from the gradation voltage select circuits 300_1 through 300_{—}m are the gradation voltages V1 through V64 equals [000000], then the output voltage is the gradation voltage V1. If the input signal DAC_ON=0, and D5 through D0=[000001], then the output voltage is the gradation voltage V2, and so on. If the input signal DAC_ON=0, and D5 through D0=[111111] then the output voltage is the gradation voltage V64.

Moreover, if the input signal DAC_ON=1, then the specified optimal gradation voltage from among the adjacent sub-groups divided into four gradations each, is output and is not dependent on the display data D1 through D0 accumulated in the second stage latch circuits 401_1 through 401_{—}m.

As shown in FIG. 4B, when the display data accumulated in the second stage latch circuits 401_1 through 401_{—}m is for example [000000] through [000011], the gradation voltage selector circuit selects the gradation voltage V2 as the optimal gradation voltage. Also, when the display data accumulated in the second stage latch circuits 401_1 through 401_{—}m is for example [000100] through [000111], then the selector circuit selects the gradation voltage V6 as the optimal gradation voltage; and so on, and when the display data accumulated in the second stage latch circuits 401_1 through 401_{—}m is [011100] through [011111], the selector circuit selects the gradation voltage V30 as the optimal gradation voltage.

When the display data accumulated in the second stage latch circuits 401_1 through 401_{—}m is [100000] through [100011], the gradation voltage selector circuit selects the gradation voltage V35 as the optimal gradation voltage. When the display data accumulated in the second stage latch circuits 401_1 through 401_{—}m is [100100] through [100111], the gradation voltage selector circuit selects the gradation voltage V39 as the optimal gradation voltage, and so on, and when the display data accumulated in the second stage latch circuits 401_1 through 401_{—}m is [1111000] through [111111], the gradation voltage selector circuit selects the gradation voltage V63 as the optimal gradation voltage.

The optimal gradation voltage is described next. In the gradation voltage V1 through V32 group having a high gradation voltage, the second highest among the gradation voltages divided into sub-groups of four gradients each is set as the optimal gradation voltage. The reason for this selection is that a transition is made to the second period just before reaching the optimal gradient voltage in the first period, in order to maintain a long drive period in the second period, and in this way allow writing a gradient voltage corresponding to the display data on the pixel at the point in time that the second period has ended in order to avoid deterioration in the image quality.

If the optimal gradation voltage was set to V1, then a transition to the second period is made at the stage where the gradation voltage at the end of the first period, reaches a voltage (gradation voltage of approximately V2 to V3) somewhat lower than the gradation voltage V1. If the gradation voltage selector circuit selected the gradation voltage V4 in the second period then the voltage potential lowers to the gradient voltage V4 from approximately the gradation voltage V2 to V3. The voltage is in this way raised to a gradation voltage V2 to V3 and the voltage then lowered to a gradation voltage V4 so that wasteful voltage fluctuations of approximately 1.5 gradations are made to occur.

If the optimal gradation voltage was set to V4, then a transition to the second period is made at the stage where the gradation voltage at the end of the first period, reaches a voltage (gradation voltage of approximately V5 through V6) somewhat lower than the gradation voltage V4. If the gradation voltage selector circuit selected a gradation voltage V1 in the second period, then the voltage potential of gradation voltage V1 must be raised approximately 4.5 gradations from gradation voltage V5 to V6. However drive performance is low since parallel drive is not used in the second period so the voltage potential might not rise to gradation voltage V1 in the second period.

In order to suppress wasteful voltage fluctuations in the first period and obtain highly efficient drive performance in the second period in this way, the optimal gradation voltage among the high gradation voltages V1 through V4 is set as gradation voltage V2, which is the second highest gradation voltage. The optimal gradation voltage among the low gradation voltages V61 through V64 is set in the same way as gradation voltage V63, which is the second from the lowest gradation voltage.

The present invention as described above is capable of separately switching one op-amp circuit, and all other op-amps on and off within each group formed by dividing the multiple op-amps into sub-groups of two or more op-amps for outputting adjacent gradation voltages. The invention can in this way operate just one op-amp among each group in the first period within one write period. The electrical power consumption can in this way be reduced.

Moreover, the outputs from op-amps other than the single operating op-amp are electrically shorted in the first period. The wiring resistance can in this way be reduced and the write period when writing onto the pixel can be shortened. In the second period following the first period, all op-amps outputting adjacent gradation voltages within a single group are set to the operating state. Gradation voltages that correspond to the display data can in this way be written onto the pixel.

Electrical current consumption in periods other than the second period can be lowered by stopping all other than one of the op-amps sub-divided into groups. This embodiment is capable of setting three of the four op-amps to the stopped state. The electrical current consumption can therefore be reduced by three-fourths in all periods other than the second period compared to when operating all of the four op-amps.

### Second Embodiment

The structure of the drive circuit of the second embodiment of this invention is described next while referring to FIG. 5. FIG. 5 is a diagram showing the structure of the drive circuit of this embodiment. The point where this embodiment differs from the first embodiment is that the gradation voltage generator circuit 200 shown in FIG. 2 has been replaced by a gradation voltage generator circuit 201, and that the switch elements DSW1 through DSW64 have been newly added. The example in this embodiment describes processing the 64 gradation display data the same as in the first embodiment. In FIG. 5, the same reference numerals are assigned to the same structural elements as in FIG. 2 and their description is omitted.

The switch elements DSW1 through DSW64 are installed on the output side of the respective op-amps OP1 through OP64. The switch elements DSW1 through DSW64 are switch circuits that switch on and off regardless of the switch elements GSW1 through GSW64. The control unit 600 controls the switch elements DSW1 through DSW64 by way of the control signals GSWON.

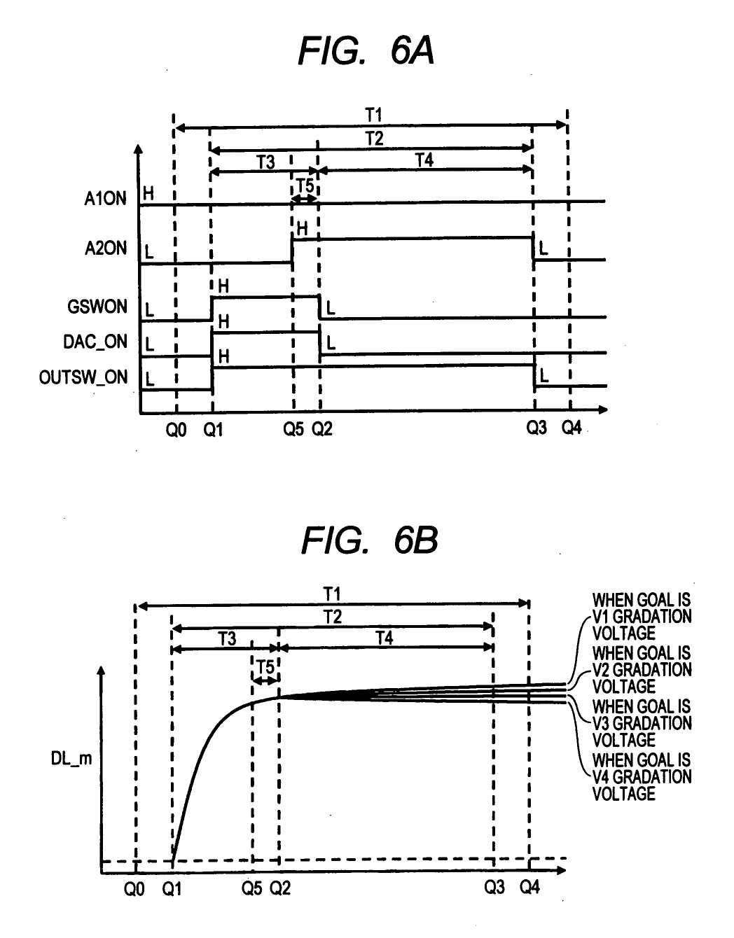

The operation of the drive circuit of this embodiment is described here while referring to FIGS. 6A and 6B. FIG. 6A is a drawing showing a waveform of each control signal (A1ON, A2ON, GSWON, OUTSW_ON) supplied to the drive circuits from the control unit 600. FIG. 6B is a graph showing voltage fluctuations along the data line DL_m. The point where FIG. 6A and FIG. 6B differ from FIG. 3A and FIG. 3B is that the control signal A2ON change timing has shifted from Q2 to Q5.

Even if an operation start signal has been input after the stop state, op-amps generally require a start-up time to allow the voltages in the internal circuitry to stabilize. In the present embodiment, the timing to start operation of op-amps (OP1, OP3, OP4, . . . , OP61, OP62, OP64) other than those outputting an optimal gradation voltage, starts earlier (Q5) than the start of the second period (Q2). The output from op-amps other than for outputting an optimal gradation voltage can in this way be stabilized by the start of the second period. The drive circuit of this embodiment can therefore smoothly write a gradation voltage corresponding to the display data in the second period, and can shorten the total write time.

The drive circuit of this embodiment moreover can stop three-quarters (¾) of the op-amps in the period T5 for Q5 through Q2 within the first period T3. The drive circuit can in this way reduce electrical power consumption within the op-amp itself.

### Third Embodiment

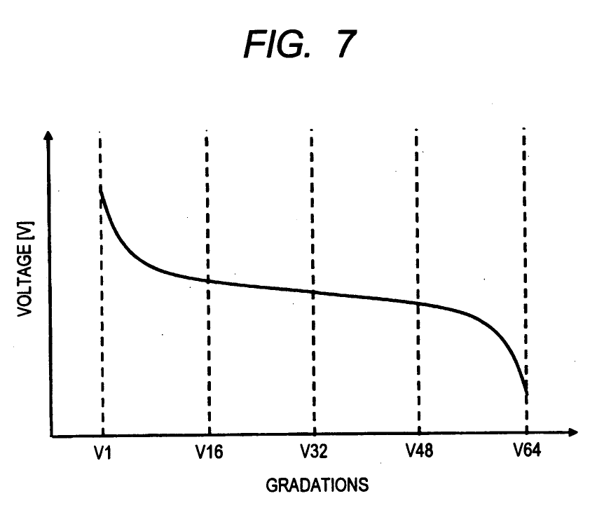

FIG. 7 is a graph showing an example of the γ (gamma) curve for the 64 gradations. In FIG. 7, the horizontal axis indicates the gradation and the vertical axis indicates the gradation voltage. The γ (gamma) curve generally differs according to the positive or negative polarity or the respective individual liquid crystal panel characteristics. In the example shown in FIG. 7 utilizing 64 gradations, there is a large differential in the adjacent optimal voltages of the upper side (gradation voltage V1) and the lower side (gradation voltage V64). However the differential between the gradation voltage in the vicinity of the middle section (gradation voltage V32) and the adjacent gradation voltages is small.

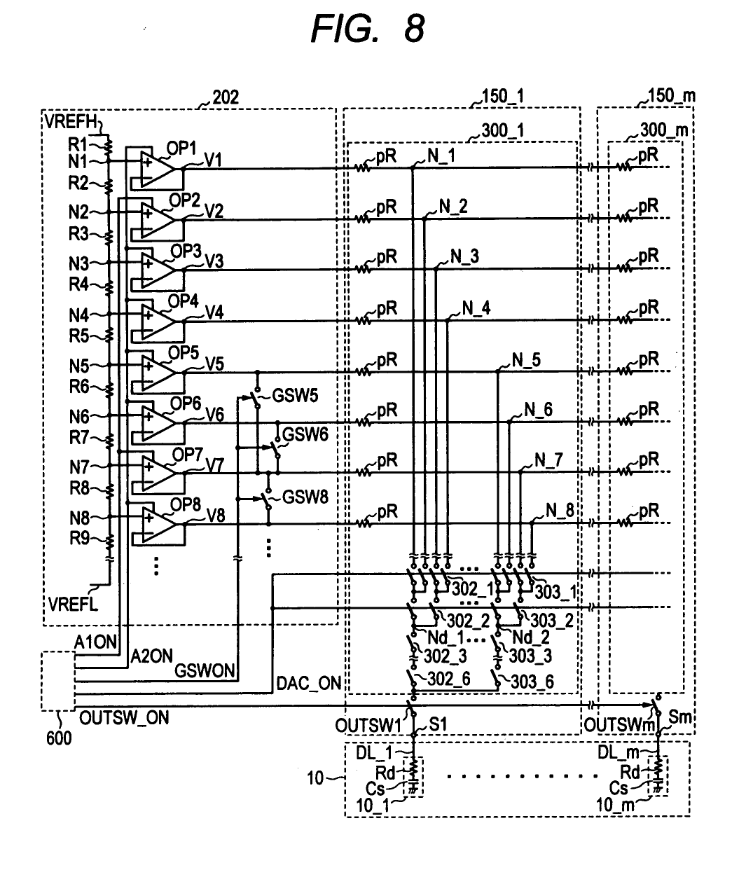

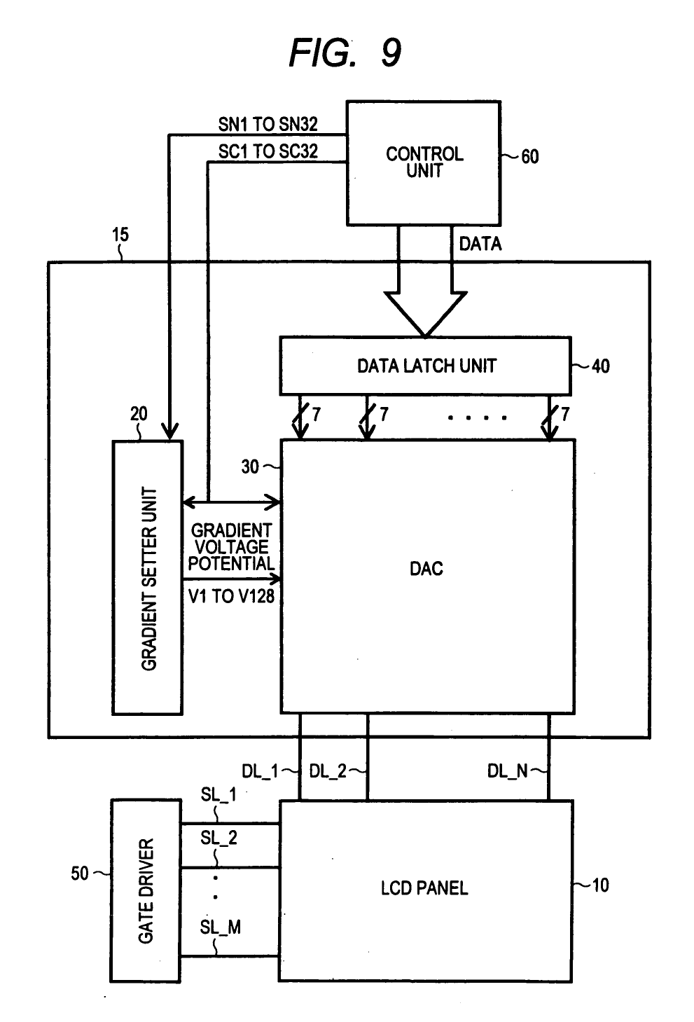

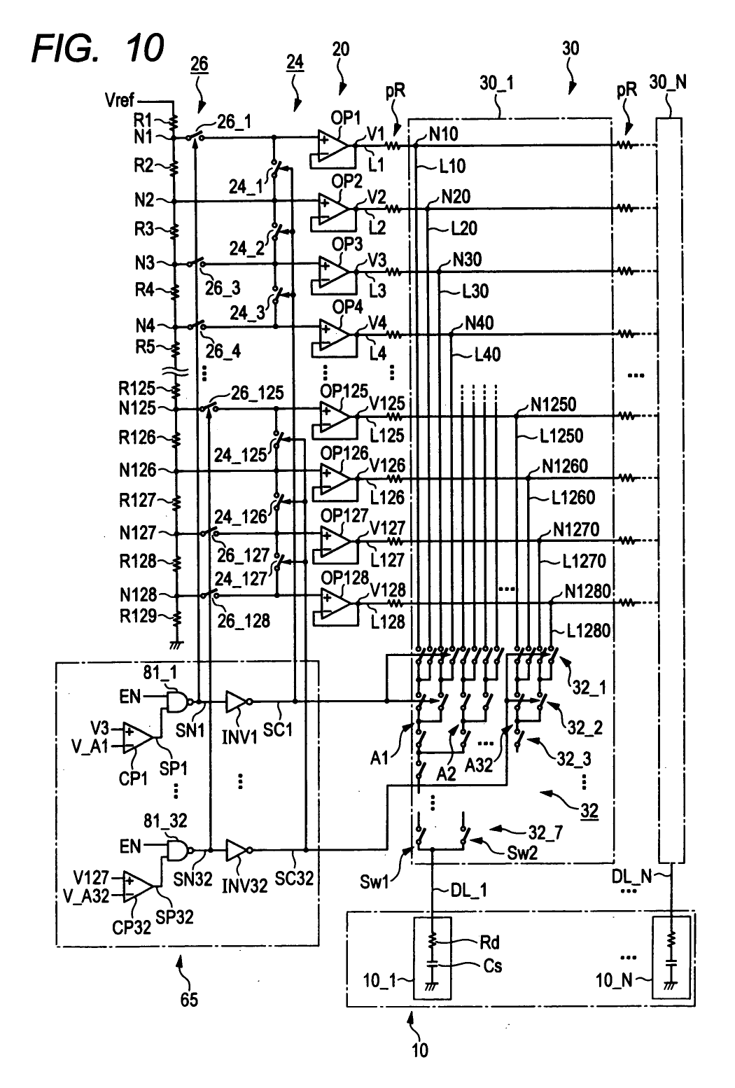

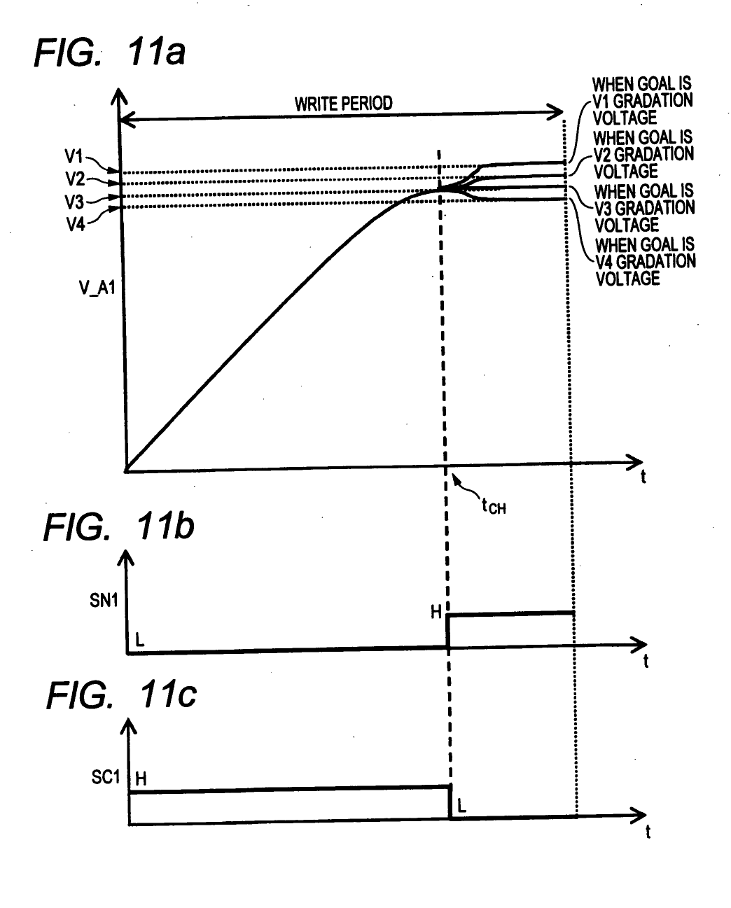

The drive circuit of this embodiment of the present invention is here applied to an LCD panel 10 having the gamma curve as shown in FIG. 7. The structure of the drive circuit of the third embodiment is described here while referring to FIG. 8. FIG. 8 is a diagram showing the structure of the drive circuit of the present embodiment. In FIG. 8, the same reference numerals are assigned to the same structural elements as in FIG. 2 and their description is omitted.

FIG. 8 shows an example of the upper eight gradation portion among the 64 gradations. Unlike the first embodiment, the upper and lower four gradation portion among the 64 gradations are not configured for parallel drive. Namely, compared to FIG. 2, there are no switch elements (GSW1 through GSW4) on the output side of the op-amp (OP1 through OP4) for electrically shorting the gradation wiring.

The timing at which the control unit 600 outputs each type of control signal is identical to the timing in the first embodiment. The control unit 600 utilizes the control signal A1ON for on and off control of the 4 gradation portion of op-amps (OP1 through OP4). The switch elements 302_1 through 302_2 of the gradation select circuit coupled to the gradation voltages V1 through V4 are constantly switching on and off according to the display data.

The group of gradation voltages V1 through V4 is not driven in parallel so the drive performance becomes small compared to the vicinity of the middle gradation group in the first period. Therefore in order to boost drive performance, the line resistance value pRL for gradation voltages V1 through V4 must be made smaller than the other line resistance pR.

The example in FIG. 8 shows the upper side eight gradation portion, however the same structure may be utilized for the lower side gradation voltages V61 through V64. In other words, there are no switch elements (GSW61 through GSW64) on the output side of the op-amp (OP61 through OP64) for electrically shorting the gradation wiring.

The control unit switches the op-amps (OP61 through OP64) on and off by way of the control signal A1ON. Also, the switch elements 303_1 through 303_2 of the gradation select circuit coupled to the gradation voltages V61 through V64 are constantly switching on and off according to the display data.

The group of gradation voltages V61 through V64 is not driven in parallel so the drive performance becomes small compared to the vicinity of the middle gradation group in the first period. The line resistance value pRL for the gradation voltages V61 through V64 must be made smaller than the other line resistance pR in order to boost the drive performance.

The present embodiment is therefore capable of suppressing increases in electrical current consumption due to voltage fluctuations when there is a large voltage differential between adjacent gradation voltages in the groups divided into sub-groups.

The present invention as described above is capable of operating just the op-amp that outputs the optimal gradation voltage and switching off all other op-amps in the initial first period of the write period within an op-amp group comprised of multiple op-amps for outputting adjacent gradation voltages. In the second period following the first period, all op-amps are operated and a gradation voltage corresponding to the display data can in this way be written onto the pixel. Electrical current consumption by the drive circuit can in this way be reduced.

The technology in Japanese Unexamined Patent Publication No. 2008-129386 includes a comparator circuit for preventing punch-through current due to the op-amps that output each gradation voltage shorting to each other. The present invention however operates only one of the grouped op-amps in the first period within one horizontal period and therefore no punch-through current flows between the op-amps. No comparator circuit is therefore needed so the drive circuit can have a smaller surface area.

The present invention moreover performs no parallel drive when there is a large differential in gradation voltages between the op-amps sub-divided into groups. The present invention in this way suppresses increased electrical current consumption while preventing undesirable voltage fluctuations during pixel writing.

The present invention is not limited to the above embodiments and all manner of changes and adaptations not departing from the scope and spirit of the present invention are permitted. The number of op-amps, the number of gradations and the γ (gamma) curves and so on for the op-amps divided into groups as described in the embodiments are only examples and do not limit this invention.

What is claimed is:

1. A drive circuit comprising:
a plurality of amplifier circuits formed for each different gradation voltage potential generated based on a reference voltage; and
a control circuit that separately switches on or off: a single amplifier circuit, and all other amplifier circuits within each group of amplifier circuits formed by dividing the amplifier circuits for outputting adjacent gradation voltages into sub-groups of two or more amplifier circuits.

2. The drive circuit according to claim 1,
wherein the drive circuit operates a single amplifier circuit in each group, and stops all other amplifier circuits in the first period during the period when writing onto the pixel; and
writes onto the pixel from the amplifier circuit with the corresponding display data in the second period following the first period.

3. The drive circuit according to claim 2, further comprising:
a first switch circuit capable of electrically shorting the output of a single amplifier circuit and all other amplifier circuits,
wherein the drive circuit electrically shorts the output of a single amplifier circuit and all other amplifier circuits in the first period.

4. The drive circuit according to claim 2, further comprising:
a gradation voltage selector circuit that outputs a specified gradation voltage not dependent on display data, within a group including the amplifier circuit that outputs a gradation voltage corresponding to the display data in the first period; and
that outputs a gradation voltage dependent on display data in the second period.

5. The drive circuit according to claim 4,
wherein the gradation voltage selector circuit includes a second switch circuit corresponding to the lower order bit of the display data installed between the output of the multiple amplifier circuits and the output terminals of the applicable gradation voltage selector circuit, and
wherein the second switch circuit is in an electrically shorted state in the first period.

6. The drive circuit according to claim 4, comprising:
a third switch circuit respectively installed between the gradation voltage selector circuit and the output of amplifier circuits other than the single amplifier circuit.

7. The drive circuit according to claim 6,
wherein the control circuit sets the first switch circuit to an electrically open state, sets the third switch circuit to an electrically shorted state, and sets the multiple op-amp circuits to the operating state immediately prior to the start of the second period.

8. The drive circuit according to claim 1, comprising:
a first group, and a second group including an amplifier circuit with a gradation voltage differential larger than the gradation voltage differential between the amplifier circuits in the first group,
wherein the amplifier circuits in the second group are controlled to separately switch on and off.

9. A drive method comprising:
grouping the amplifier circuits formed for each different gradation voltage generated based on a reference voltage into groups of two or more amplifier circuits that output adjacent gradation voltages;
operating a single amplifier circuit and stopping all other amplifier circuits in each group, in the first period during the period when writing onto the pixel; and
writing onto the pixel from the amplifier circuit with the corresponding display data in the second period following the first period.

10. The drive method according to claim 9, further comprising:
electrically shorting the output of a single amplifier circuit and all other amplifier circuits in the first period.

11. The drive method according to claim 9, further comprising:
outputting a specified gradation voltage not dependent on display data, within a group including the amplifier circuit that outputs a gradation voltage corresponding to the display data in the first period; and
outputting a gradation voltage dependent on display data in the second period.

12. The drive method according to claim 4, further comprising:
setting the output terminals and the output of the amplifiers to an electrically shorted state in the first period.

13. The drive method according to claim 9, further comprising:
the control circuit canceling the electrically shorted state between the output of the single amplifier circuit and all other amplifier circuits immediately prior to the start of the second period, and setting the op-amps to the operating state.

14. The drive method according to claim 9, further comprising:
operating a single amplifier circuit and stopping all other amplifier circuits in the group, in periods other than the second period.

15. The drive method according to claim 9, the groups including a first group, and a second group having an amplifier circuit with a gradation voltage differential larger than the gradation voltage differential between the amplifier circuits in the first group, the method comprising:
causing the amplifier circuits in the second group to be controlled to separately switch on and off.
